(19) United States
(12) Patent Application Publication
(10) Pub. No.: US 2014/0141200 A1
(43) Pub. Date: May 22, 2014

(54) Plastic Tiles for Use on Vessels

(71) Applicant: G Theodor Freese GMBH & Co., KG, Bremen (DE)

(72) Inventor: Hermann Kassens, Papenburg (DE)

(73) Assignee: G Theodor Freese GMBH & Co., KG, Bremen (DE)

(21) Appl. No.: 14/067,881

(22) Filed: Oct. 30, 2013

(30) Foreign Application Priority Data
Oct. 30, 2012 (DE) 10 2012 219 826.1

(51) Int. Cl. B63B 17/00; B29C 39/02

(52) U.S. Cl. CPC B63B 17/00; B29C 39/026
USPC 428/141; 264/240; 156/245

(57) ABSTRACT

A tile element for use in technical wet areas on vessels with a slip resistant surface with a first macroscopic waviness and a microscopic roughness, a rectangular shape designed for grouted laying of several tiles in an abutting arrangement, and a lower adhesion surface is provided. A method for producing a slip resistant vessel floor covering for technical wet areas is also provided. The tile element consists of plastics and is produced from at least two different raw materials in a chemical cross-linking reaction.

The invention relates to a tile element for the use in technical wet areas on vessels with a slip resistant surface with a first macroscopic waviness and a microscopic roughness, a rectangular shape designed for grouted laying of several tiles in an abutting arrangement, and a lower adhesion surface. Another aspect of the invention is a method for producing a slip resistant vessel floor covering for technical wet areas.

Floor coverings on vessels are subject to increased demands regarding their functional characteristics—in contrast to floor coverings installed in buildings. The reason for this is that on vessels as well as in buildings—in contrast to other vehicles—persons, in particular the staff of the vessel, need to perform several services and activities there and move around, which, however, requires a special grip on the floor for those people due to vessel movements. In addition, vessel movements and driving impacts of the vessel have mechanical influences on the floor coverings of vessels, which the vessel floor must withstand for a long period of use without its characteristics being affected.

Technical wet areas on a vessel are a particular challenge in this case. A technical wet area is a room in which a service or an activity is performed that may lead to the fact that the floor becomes and remains wet during the performance of the work, or that requires the floor to be cleaned with a wet cleaning technique. In such wet areas, liquid on floors, in particular water, but possibly also other liquids, such as oils, fuels, drinkable liquids or liquids used for or resulting from food preparation and the like, significantly reduce adhesion between the soles of the persons walking on the floor covering and the floor itself.

It is known to install tiles made of ceramic material in such technical wet areas on vessels. These tiles have the benefit of possessing a natural roughness, which is obtained in the course of the manufacturing process. Furthermore, it has proven to be advantageous that tiles can be produced profitably and efficiently, above all if they have a typical size of about 15 cm, are square or at least have similar dimensions. Ceramic tiles of said size have a low risk of breakage and a low reject rate in production, and the tiles can be installed with the usual effort. When using tiles of this size, a distance is required between neighboring tiles resulting in gaps between the tiles, which are filled with a cement and mortar mixture. The gaps are thus production-related drainage channels in which liquids can drain off the tile surface, thus reducing the risk of a lubricant film formation.

Ceramic tile floor coverings have proven successful in practical use, as they fulfill the particular requirements of floor coverings in technical wet areas on vessels, which are in part also regulated by professional organizations, or in workplace regulations and the like. However, there is still room for improvement regarding this type of floor covering, in particular as the installation is very work-intensive, and disadvantages have become apparent during prolonged use. These disadvantages are that, with ceramic tiles, it is very difficult to connect the tile to corresponding connecting elements in the edge region of the floor covering in a permanent and liquid-tight manner; this connection can become leaky, in particular over a long period of time, which can result in damages in the area of the foundation.

The object of the invention is to provide a floor covering which is made for a technical wet area of a vessel but which can overcome these disadvantages.

According to the invention, the problem is solved with the tile element described above, with the tile element consisting of plastics and being produced of at least two different raw materials in a chemical cross-linking reaction.

According to the invention, a tile element made of a polymer material is provided comprising a first macroscopic waviness and a microscopic roughness at its surface. This embodiment on the one hand allows larger liquid volumes to drain off into the depth ranges of the first macroscopic waviness, thus generally increasing slip resistance by replacing the function of the gaps of a floor covering consisting of ceramic tiles. This makes it possible to provide the tile element in one piece in a much larger dimension than is the case with a ceramic tile element; thus, the tile made of plastic according to the invention, for example, can be produced and installed with the dimensions 1.0×1.0 m. The tile element further comprises a microscopic roughness in the slip resistant surface, which overlays the first macroscopic waviness. Said microscopic roughness provides for a mechanical grouting and interlocking effects with the soles of people stepping on the surface, and allows the displacement of smaller quantities of liquid from the contact areas between a sole and the surface. In principle, it has to be understood that the macroscopic waviness and microscopic roughness are superimposed and distinguish themselves in that the macroscopic waviness is larger than the corresponding geometrical specific values of the microscopic roughness, both with regard to the distance of the recesses and elevations constituting the waviness, and with regard to their height or depth by at least one size, i.e., by at least the factor 5 to 15, preferably 10.

The plastic material of which the tile element is composed on the surface is made from at least two different raw materials. This is done by means of a chemical cross linking reaction, which can be a polymerization, polyaddition or polycondensation. In particular, resins such as epoxy resins are possible plastic materials for the tile element, but other polymers, such as polyurethane, polyamides or the like, may also be used.

Fillers can be added to the plastic material, whereby it is preferred in particular to distribute quartz-bearing fillers in the plastic material. Said fillers can preferably comprise >10% by weight in the plastic material. The quartz-bearing fillers allow for a wear-resistant surface with characteristics of fine sandpaper, whereby said structure is also maintained for a very long operating period due to the use of the tile elements with elastic recovery of the plastic components, which wear faster than the quartz-bearing components, and the according protrusion of the fillers.

Furthermore, it is preferred that the slip resistant surface of the tile element according to the invention have a ball indentation hardness of at least 150, preferably >250 N/mm², measured as the 10 seconds value according to DIN 53456. Such hardness helps to ensure the effectiveness of the slip resistance by means of the microscopic roughness and the macroscopic waviness compared to the usual sole materials of shoes, and at the same time to prevent wear on the surface of the tile element, which would decrease said effectiveness.

It is particularly preferred that the first macroscopic waviness be reached by means of one or several drainage channels, which have a deeper channel floor than the slip resistant surface of the tile element. Said design of the first macroscopic waviness allows for the drainage channels to absorb liquids resting on the tile element and, if necessary, lead them away. This does not lead to a liquid lubrication that would affect the adhesive coefficient of the surface of the tile element, and ensures a strong grip of a user's shoe sole, thus preventing slipping.

It is further preferred that the tile element comprise several surface sections separated from each other by drainage channels, and preferably that these surface sections and drainage channels be arranged according to the grouted tiles, whereby the drainage channels reproduce the gaps and the surface sections of the tiles. This structure on the one hand allows the function of the drainage channels to be combined with the visually well-known image of a floor consisting of individual grouted tiles. Furthermore, said structure can complement the surface or improve the existing tile surface of a floor with the tile element according to the invention. The gap image reproduced by the drainage channels can in particular be designed according to the style of butt joints with a concave arched channel floor so as to ensure good drainage through the channels.

The tile element according to the invention can further comprise a second macroscopic waviness, which is formed by a plurality of elevations on the slip resistant surface. Said second waviness is located on the surface of the tile element, and thus in the contact area to a shoe sole of a user of the surface. Said second waviness, which can be designed having rounded elevations, geometrically regular or irregular structures, pyramidal structures with a distinct tip, such as tetrahedron, pentrahedron or the like, pins, knobs, tips and other geometrical forms for grouting with the shoe sole, ensures a mechanical form closure by indentation in the sole of a user stepping on the tile element and adding a load of stress to it with his body weight. This helps to additionally prevent sideways slipping on the tile element.

Furthermore, it is preferred that the first macroscopic waviness be realized through a different thickness of the tile element with a difference between the minimum and maximum thickness of >0.2 millimeters, or by drainage channels with a depth of 0.2 to 1.5 mm and a width of 2 to 10 mm, preferably 3 to 5 mm. For the installation of the tile element, it is advantageous if the lower adhesion surface is even, whereby this means a plane lower surface, which can, as the case may be, have grooves or a roughness so as to ensure better bonding with mechanical grouting. The variation of the thickness of the tile element in the cross section of the tile element allows for a macroscopic waviness ensuring that, during use, there are always protruding surface areas that do not allow liquid volumes to rest on them, which instead can drain off into deeper areas with a lower wall thickness of the tile.

Furthermore, it is preferred that the second macroscopic waviness be implemented by a surface of the tile element with
Rp between 0.2 and 1.5 millimeters preferably
Rp between 0.4 and 0.8 millimeters and in particular
Rp between 0.65 and 0.75 millimeters
   over a referenced evaluation distance of 5 cm. Said further embodiment comprises a first or a second macroscopic waviness, which causes a secure drainage of liquids on the one hand, and reaches a sufficient mechanical form closure on the other hand; thereby, the dimensions are kept to a minimum so as to prevent stumble or undesired catching of the user's feet on the surface.

Pursuant to another preferred embodiment, it is provided that the second macroscopic waviness is formed by a roughness of the surface of the tile element with 2-20 elevations/10 cm² referenced evaluation distance, in particular with 3-10 local roughness peaks over a referenced evaluation distance of 10 cm. Said further embodiment provides a sufficient structural dimension of the second macroscopic waviness so as to arrange the raised surfaces of the tile in such a way that at least one of the raised surface sections of the user's shoe sole is always caught, which allows for a secure grip.

Furthermore, it is preferred that the microscopic roughness be implemented by a surface of the tile element with
Rp between 0.02 and 0.40 millimeters, preferably
Rp between 0.04 and 0.15 millimeters in particular
Rp between 0.05 and 0.055 millimeters
   over a referenced evaluation distance of 1 cm. Said further embodiment provides for an efficient microscopic roughness, which can be superimpose upon the macroscopic waviness, and which can cause, in direct contact between a shoe sole of a user stepping on the tile element and the surface of the tile element itself, a fast and efficient displacement of liquid volumes in the valleys of the microscopic roughness. It has to be understood that the microscopic roughness can be provided over the overall surface of the tile element, but also only on sections of this surface: for example, only the raised sections of the surface of the tile element which are provided with the macroscopic waviness.

Furthermore, it is preferred that the microscopic roughness be formed by a roughness of the surface of the tile element with 3-10 local roughness peaks over a referenced evaluation distance of 1 cm. Said “wavelength” of the microscopic roughnesses secures that the displacement paths of the water in contact with the user's shoe sole are not too long, but are sufficiently short to secure an efficient displacement of liquid from the contact areas between the sole and the surface of the tile.

A further aspect of the invention is a method of producing a slip-resistant vessel floor covering for technical wet areas, including the following steps:
a) providing a casting mold with a cavity or recess comprising a negative mold for a surface with a first macroscopic waviness in the shape of one or several drainage channels, a second macroscopic waviness in the shape of several elevations over the surface and a microscopic roughness, which is preferably designed according to one of the claims 3-11,
b) mixing a first component with a second component that is different from the first to achieve a liquid two-component mixture,
c) filling the two-component mixture into the casting mold,
d) removing a tile element from the casting mold following the reaction and hardening of the two-component mixture.

Said method allows for tile elements to be efficiently prefabricated for technical wet areas on vessels, and to be produced and transported with a low weight compared to the known ceramic tiles for such applications. In addition, the method according to the invention allows for the production of tile elements with larger dimensions than known ceramic tiles, which makes the installation occur much more quickly and with fewer sources of error. The casting mold is preferably a negative mold of the macroscopic waviness and microscopic roughness so as to accurately transfer it to the corresponding cast plastic tile. The casting mold is preferably suitable for multiple uses so that it can be refilled after the removal of a hardened tile in order to produce another tile. The hardening of the material is preferably reached by means of a chemical cross-linking reaction, which can be a polymerization, polyaddition or polycondensation. With regard to the geometrical specific values of the macroscopic waviness and the microscopic roughness, reference is made to the above explanations regarding the tile element according to the invention. In particular, the method according to the invention can be embodied by taking the following steps after the removal of the tile element from the casting mold:
a) transporting several tile elements to the place of installation and
b) gluing a lower adhesion surface of the tile elements to a floor using a visco-elastic bonding material.

Bonding of the tile element with the floor using a visco-elastic bonding material provides the advantage of a very effective footfall sound insulation and footfall sound development, which is particularly advantageous on standard vessel floors made of steel.

Furthermore, it is preferred that the method according to the invention be embodied by the grouting of an edge of the tile element against a stainless steel base or a stainless steel profile with a synthetic resin material, preferably an unfilled synthetic resin material. Grouting the edge of the tile elements against a stainless steel base provides for a permanent and secure sealing of the entire floor covering against border areas or borders or the like, complying with the high corrosion resistance requirements and the high need of cleaning on vessels. Using an artificial resin for said grouting provides for a general elasticity that does not suffer long-term damage (e.g., cracks) due to vibration of the hull, such as through drive-induced influences. At the same time, a grouting material is provided which is easy to work with, and which can be processed without the need to comply with complex occupational safety requirements.

Finally, it is furthermore preferred that the method be embodied by a flush juxtaposition of the tile elements without separate gap filling between two neighboring tile elements. Said flush juxtaposing provides for a sealing between the tile elements by the bonding material of the lower surfaces of the tile elements, and the grouting process between the neighboring tile elements can be omitted, which ensures a secure sealing on the one hand and a fast installation on the other.

The invention provides for a tile for use in technical wet areas on vessels, which has a much lower weight than known ceramic tiles for such areas, and which can be more quickly installed. The slip resistance and displacement factor are equivalent or superior to the characteristic values of a ceramic tile. The material is less expensive, which can be achieved in particular by means of fillers that can further increase slip resistance. The number of gaps is significantly reduced due to possible larger dimensions. The development and transmission of footfall sound can be reduced by the tile itself, in particular also through the possible bonding of the tile with a visco-elastic material. A better adhesion of the tile edges on stainless steel bases is accomplished, as no grout mortar is used, but unfilled artificial resin material, which can prevent cracks or even breaks in the stainless steel base when used for a prolonged period. Due to their general flexibility, the tiles provided according to the invention are clearly less sensitive to breakage during transport, installation and later use.

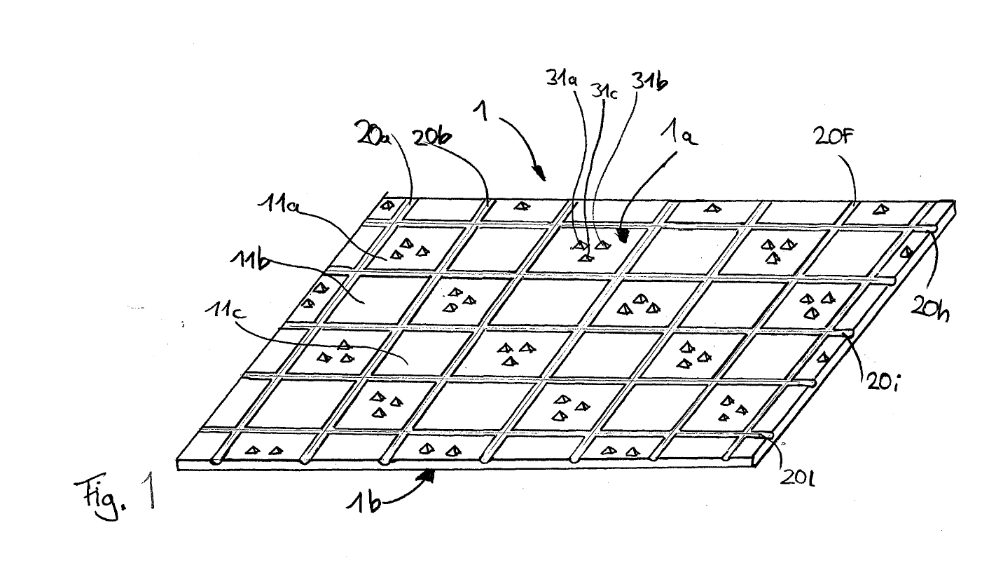

An exemplary embodiment of a tile according to the invention is explained through the attached FIG. 1:

FIG. 1 shows a tile element 1 in a perspective view. The tile element has a slip-resistant surface 1a, which is in contact with a user's shoe sole moving on it. On the opposite side of said slip-resistant surface, the tile has a lower adhesion surface 1b, which is flat and can have a roughened surface that is advantageous for bonding, such as a surface profile with grooves. The tile is rectangular and its edges have the dimensions 1.5×1.0 m.

The surface has a first macroscopic waviness with several drainage channels 20a-l. The drainage channels effectively discharge liquids from the surface 1a and thus prevent that the user slips on liquid accumulations. The drainage channels subdivide the tile element in several sections 11a, b, c and cause a visual image of the tile element according to several grouted tiles. As the surface sections have a bisected area along the edge area and the surface sections in the corner areas of the tile element have a quartered area, the image of a large tiled area can be reached by installing several tile elements next to each other without gaps. In alternative embodiments, it is also possible to choose a different design of the edge area, such as with a drainage channel, which is divided along the direction of its pattern, running in the middle of the edge area.

Furthermore, there is a second macroscopic waviness in the shape of several pyramid-shaped elevations 31 a, b, c, . . . on the surface sections 11 a, b, c . . . with the result that the tile has a total of around 50 elevations on its base area of 1.5×1.0 m that are raised opposite the surface 1a and the drainage channels 21a-l that lie in between. A user of the tile basically stands on these elevations or can stand without slipping due to mechanical grouting. Liquids on the floor tile basically flow into the drainage channels, thus not hindering the contact between the user's sole and the floor tile. The elevations 31a,b,c, . . . can be formed on each or only on some of the surface sections 11 a,b,c . . . .

A microscopic roughness is superimposed upon the macroscopic waviness and can thus cause a mechanical grouting between a user's shoe sole and the slip resistant surface, as well as a displacement of liquids remaining on the elevations. The microscopic roughnesses are basically designed in the area of surface 1a and elevations 31a, b, c, . . . of the floor tile. The drainage channels 21a-l can also have a microscopic roughness; however, it is preferred that they have a surface that can be cleaned easily, such as a basically flat surface.

The floor tile according to the invention is produced by mixing two different raw materials to obtain a two-component-mixture, and then filling it into a mold. Both material react with each other, thus hardening to a plastic. After the hardening, the tile produced according to this method can be removed from the mold and installed without any additional finishing steps. For this purpose, the tile is transported from its production location to its place of installation, where it can be bonded with a base, such as with a steel base of a vessel, using a visco-elastic adhesive.

1. Tile element for use in technical wet areas on vessels, comprising:
a slip resistant surface with a first macroscopic waviness and a microscopic roughness;
a rectangular shape for grouted or non-grouted installation of several tiles in an abutting arrangement; and
a lower adhesion surface,
wherein the tile element comprises plastics and is produced from at least two different raw materials in a chemical cross-linking reaction.

2. Tile element according to claim 1, wherein a portion of more than 10% in weight is quartz-bearing fillers.

3. Tile element according to claim 1, wherein the first macroscopic waviness is realized having a different thickness of the tile element with a difference between the minimum and maximum thickness of >0.2 millimeters, or by drainage channels with a depth of 0.2 to 1.5 mm and a width of 2 to 10 mm, preferably 3 to 5 mm.

4. Tile element according to claim 1, wherein the first macroscopic waviness is reached by means of one or several drainage channels, which have a deeper channel floor than the slip resistant surface of the tile element.

5. Tile element according to claim 4, wherein the tile element comprises several surface sections separated from each other by drainage channels, the surface sections and drainage channels arranged according to grouted tiles, whereby the drainage channels reproduce gaps and the surface sections of the tiles.

6. Tile element according to claim 1, wherein a second macroscopic waviness is formed by a plurality of elevations on the slip resistant surface.

7. Tile element according to claim 6, wherein the second macroscopic waviness is implemented by a surface of the tile element with Rp between 0.2 and 1.5 millimeters, preferably Rp between 0.4 and 0.8 millimeters, and in particular Rp between 0.65 and 0.75 millimeters over a referenced evaluation distance of 5 cm.

8. Tile element according to claim 6, wherein the second macroscopic waviness is formed by a roughness of the surface of the tile element with 2-20 elevations/10 cm², in particular with 3-10 local roughness peaks over a referenced evaluation distance of 10 cm.

9. Tile element according to claim 1, wherein the microscopic roughness is implemented by a surface of the tile element with Rp between 0.02 and 0.40 millimeters, preferably Rp between 0.04 and 0.15 millimeters in particular Rp between 0.05 and 0.055 millimeters over a referenced evaluation distance of 1 cm.

10. Tile element according to claim 1, wherein the microscopic roughness is formed by a roughness of the surface of the tile element with 3-10 local roughness peaks over a referenced evaluation distance of 1 cm.

11. Method of producing a slip-resistant vessel floor covering for technical wet areas, comprising:
providing a casting mold with a cavity or a recess comprising a negative mold for a surface with a first macroscopic waviness in the shape of one or several drainage channels, a second macroscopic waviness in the shape of several elevations over the surface and a microscopic roughness;
mixing a first component with a second component that is different from the first to achieve a liquid two-component mixture;
filling the two-component mixture into the casting mold; and
removing a tile element from the casting mold following the reaction and hardening of the two-component mixture.

12. Method according to claim 11, further comprising:
transporting several tile elements to a place of installation; and
gluing a lower adhesion surface of the tile elements to a floor using a visco-elastic bonding material.

13. Method according to claim 11, further comprising:
grouting an edge of the tile element against a stainless steel base or a stainless steel profile with a synthetic resin material, preferably an unfilled synthetic resin material.

14. Method according to claim 11, further comprising:
flush juxtaposing at least two tile elements without separate gap filling between two neighboring tile elements.

15. Method according to claim 11, wherein the casting mold is configured to produce the first macroscopic waviness having a different thickness of the tile element with a difference between the minimum and maximum thickness of >0.2 millimeters, or by drainage channels with a depth of 0.2 to 1.5 mm and a width of 2 to 10 mm, preferably 3 to 5 mm.

16. Method according to claim 11, wherein the casting mold is configured to produce several surface sections separated from each other by the drainage channels, the surface sections and drainage channels arranged according to grouted tiles, whereby the drainage channels reproduce gaps and the surface sections of the tiles.

17. Method according to claim 11, wherein the casting mold is configured to implement the second macroscopic waviness by a surface of the tile element with Rp between 0.2 and 1.5 millimeters, preferably Rp between 0.4 and 0.8 millimeters, and in particular Rp between 0.65 and 0.75 millimeters over a referenced evaluation distance of 5 cm.

18. Method according to claim 11, wherein the second macroscopic waviness is formed by a roughness of the surface of the tile element with 2-20 elevations/10 cm², in particular with 3-10 local roughness peaks over a referenced evaluation distance of 10 cm.

19. Method according to claim 11, wherein the microscopic roughness is implemented by a surface of the tile element with Rp between 0.02 and 0.40 millimeters, preferably Rp between 0.04 and 0.15 millimeters in particular Rp between 0.05 and 0.055 millimeters over a referenced evaluation distance of 1 cm.

20. Method according to claim 11, wherein the microscopic roughness is formed by a roughness of the surface of the tile element with 3-10 local roughness peaks over a referenced evaluation distance of 1 cm.
